(19) United States
(12) Patent Application Publication
(10) Pub. No.: US 2025/0331439 A1
(43) Pub. Date: Oct. 30, 2025

(54) OBSTACLE AVOIDANCE BY AUTOMATICALLY SHIFTING A GUIDANCE LINE

(71) Applicant: Deere & Company, Moline, IL (US)

(72) Inventors: Glen L. OETKEN, Ankeny, IA (US); David August JOHNSON, Durham, NC (US)

(21) Appl. No.: 18/644,923

(22) Filed: Apr. 24, 2024

(51) Int. Cl. A01B 69/04

(52) U.S. Cl. CPC A01B 69/008

(57) ABSTRACT

A control system obtains a location of an obstacle in a field and an overall width dimension of an agricultural machine configured to follow a guidance line through the field. The control system detects a potential collision based upon the overall width of the agricultural machine and the location of the obstacle relative to the guidance line and regenerates the guidance line to avoid the potential collision.

### FIELD OF THE DESCRIPTION

The present description relates to agricultural systems. More specifically, the present description relates to automatically shifting a guidance line used to navigate a mobile agricultural machine to avoid a collision with an obstacle, based upon the overall width of the mobile agricultural machine and the location of the obstacle.

### BACKGROUND

There are a wide variety of different types of agricultural equipment. Such agricultural equipment can include mobile agricultural machines, such as planting machines, sprayers, tillage machines, harvesting machines, among a wide variety of others.

Some mobile agricultural machines are navigated autonomously or in a hands-free way. In such machines, a path planning system identifies the boundary of a field in which the agricultural machine is to operate and then populates the field with guidance lines. The machine is then automatically or manually navigated along the guidance lines. For instance, a navigation system may automatically control the propulsion and steering subsystems on the agricultural machine in order to navigate the agricultural machine along a guidance line. At the end of a row, the machine May automatically turn to begin following another guidance lines, or the turns can be controlled manually as well.

The discussion above is merely provided for general background information and is not intended to be used as an aid in determining the scope of the claimed subject matter.

### SUMMARY

A control system obtains a location of an obstacle in a field and an overall width dimension of an agricultural machine configured to follow a guidance line through the field. The control system detects a potential collision based upon the overall width of the agricultural machine and the location of the obstacle relative to the guidance line and regenerates the guidance line to avoid the potential collision.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1, 2, 3, 4, 5, and 6 are pictorial illustrations showing mobile agricultural machines following guidance lines.

FIG. 7 is a block diagram showing one example of an agricultural machine in more detail, as part of an agricultural system.

FIG. 8 is a flow diagram illustrating one example of the operation of the agricultural machine.

FIG. 9 is a block diagram showing the agricultural system illustrated in FIG. 7, deployed in a remote server environment.

FIGS. 10, 11, and 12 show examples of mobile devices that can be used in the systems and architectures shown in other figures.

FIG. 13 is a block diagram of one example of a computing environment that can be used in the systems and architectures shown in other figures.

### DETAILED DESCRIPTION

As discussed above, in some current systems, a path planning system generates guidance lines for an agricultural machine in a field. A navigation system controls controllable subsystems (such as a propulsion subsystem and a steering subsystem) on the agricultural machine to navigate the agricultural machine along the guidance lines. The agricultural machines have an operating width which may be referred to as a track width. For instance, a planting machine May be a twelve row planting machine, with twelve row units spaced transversely (relative to the direction of travel), each planting a row. The planting machine may thus have an operating width or track width that is measured as the distance between the row unit on one transverse end of the planting machine (e.g., one outermost row unit) to the row unit on the opposite transverse end of the planting machine (e.g., the other outermost row unit).

In some current path planning systems, a guidance line is generated one half of a track width away from the field boundary. Therefore, one of the outermost row units on one transverse end of the planting machine will be planting closely adjacent the boundary of the field.

However, this can present problems. Some agricultural machines have an overall width that is greater than the track width or operating width of the machine. For instance, a planting machine may have part of the frame or other hardware that extends outward, transversely, beyond the outermost row unit. This may be referred to as an overhang portion of the agricultural machine in that it extends transversely beyond the track width or operating width of the machine. Such machines may have overhang portions on both ends of the machine. There may be obstacles, such as rock piles, power poles, trees, fence posts, etc., that are outside the boundary of a field, but closely adjacent the boundary of the field. Further, such obstacles may lie on the boundary of the field. In such scenarios, the overhang portion of the agricultural machine may come into contact with that obstacle, even though the obstacle is on or outside the boundary of the field, and even though the obstacle is outside of the operating width or track width of the agricultural machine.

In other examples, there may be obstacles within a field. Current path planning systems may generate a guidance line so that the guidance line is located one half of the working width (or one half of the track width) away from the obstacle in the field. However, because the overhang portion of the agricultural machine extends beyond the track width or operating width of the machine, that overhang portion may come into contact with the obstacle.

Thus, in one example, the present description describes a system that detects or obtains access to the overall width of the agricultural machine and determines whether any hangover portion of the agricultural machine will contact an obstacle. If so, the guidance line is shifted to avoid that contact. In one example, the guidance line may be shifted in its entirety, such as inwardly along a field boundary, or a portion of the guidance line may be shifted to deviate around obstacles. Similarly, the present description describes a system that identifies obstacles that may collide with the overhang portion of an agricultural machine, where the obstacle is within the field boundary. The present system modifies the guidance lines to avoid such an obstacle. In one example, an operator can interact with an operator interface to flag or otherwise mark the location of obstacles, and also define the size of the obstacles. In another example, the locations of the obstacles and the size of those obstacles is automatically detected and/or a default size is used. The present system also accommodates agricultural machines that tow other machines where the different machines each have a frame with its own dimensions. The towed machines may follow a different path than the towing machine. Based on the machine dimensions, the present system can calculate the path of each of the machines (towing machines and towed machines) so that the guidance line can be adjusted to avoid a collision between any of the machines and the obstacle.

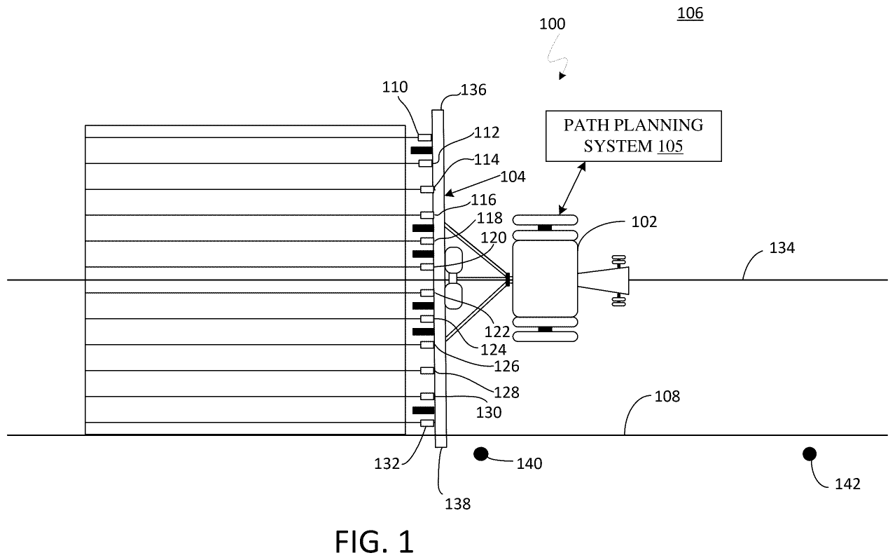

FIG. 1 is a pictorial illustration showing one example of an agricultural machine 100 which includes a towing vehicle (e.g., a tractor) 102 towing an implement, such as a row unit planter 104 through a field 106. Agricultural machine 100 is pulling implement 104 adjacent a field boundary 108. In the example shown in FIG. 1, implement 104 includes a plurality of different row units 110, 112, 114, 116, 118, 120, 122, 124, 126, 128, 130, and 132. Each row unit plants seeds in a row. The rows are indicated in FIG. 1 by the lines following implement 104.

Also, in the example shown in FIG. 1, a path planning system 105 (described in greater detail below) has generated a guidance line 134. Tractor 102 includes a navigation system that automatically follows guidance line 134 through field 106. Guidance line 134, in the example shown in FIG. 1, is generated based upon the dimensions of implement 104 where those dimensions include the track width or operating width of implement 104 defined as the distance between the two outermost row units 110 and 132. The path planning system 105 generates guidance line 134 so that row unit 132, adjacent boundary 108, plants its row closely proximate boundary 108.

However, the overall width of implement 104 is defined as the distance between the ends 136 and 138 of implement 104. Thus, there is an overhang portion on implement 104 between row unit 110 and end 136 or implement 104, and another overhang portion between row unit 132 and the end 138 of implement 104. Thus, the overall width between ends 136 and 138 is greater than the operating width or track width measured between row units 110 and 132, and the path planning system 105 that generated guidance line 134, in current systems, does not account for that overall width.

This can lead to problems. For instance, in the example shown in FIG. 1, a plurality of obstacles 140 and 142 (in the example shown in FIG. 1 obstacles 140 and 142 are power poles) are outside of boundary 108 but closely proximate boundary 108. Therefore, the overhang portion of implement 104 measured between row unit 132 and end 138 will come into contact with obstacles 140 and 142 if tractor 102 continues to follow guidance line 134. This is because the path planning system 105 used to generate guidance line 134 only takes into account the track width or operating width of implement 104 measured between row unis 110 and 132.

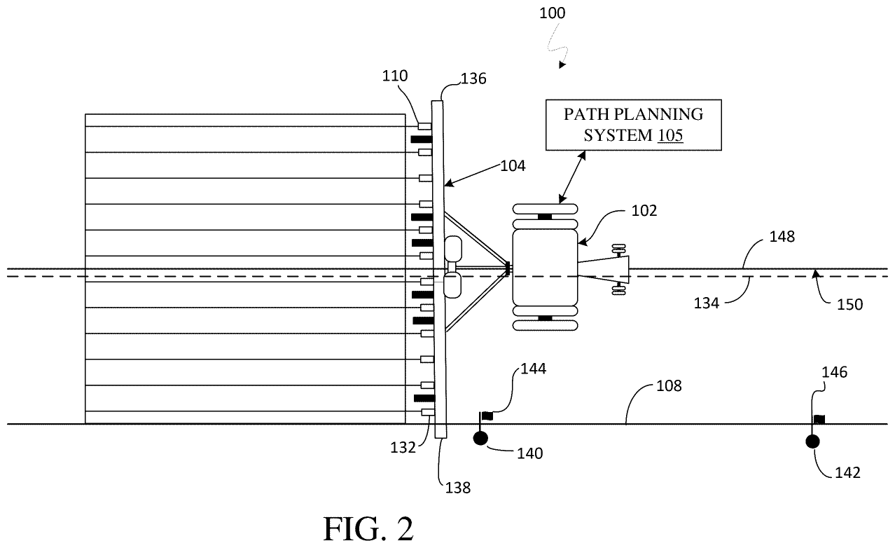

Thus, as shown in FIG. 2, the present description describes a system in which the path planning system 105 allows an operator or other user to mark obstacles 140-142 (such as by dropping a flag 144-146 on obstacles 140-142 in a mapping system or by marking them in other ways). Also, in one example, the operator can define the dimensions of the obstacles 140-142. The dimensions can be defined in various ways such as by using a default dimension, an operator configured dimension, or in other ways. In another example, the location and/or size of obstacles 140-142 can be automatically detected. Further, the path planning system 105 of the present discussion also considers the overall width of implement 104 measured between ends 136 and 138, and not just the track width or operating width of implement 104 measured between row units 110 and 132.

Thus, FIG. 2 shows an example in which the path planning system 105 described herein can re-generate guidance line 134, shifting it to the position of guidance line 148 so that end 138 will not contact the obstacles 140-142. In the example shown in FIG. 2, the path planning system 105 has shifted guidance line 134 in the direction generally indicated by arrow 150 to the location indicated by guidance line 148. Thus, when following guidance line 148, the entire implement 104 is shifted inside the boundary 108 (or is shifted sufficiently to avoid contacting obstacles 140-142) during operation.

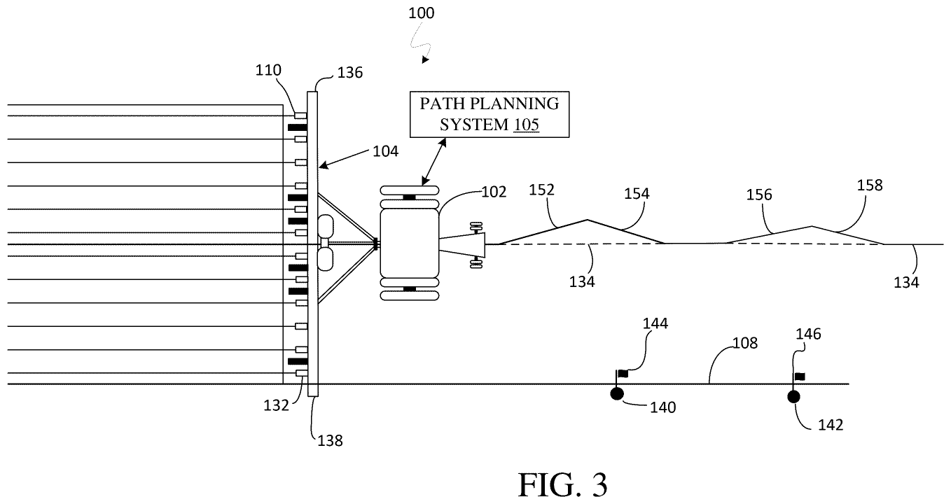

FIG. 3 illustrates another example of the operation of the path planning system 105 in generating a guidance line for agricultural machine 100. Some items are similar to those shown in FIGS. 1 and 2 above, and they are similarly numbered. In FIG. 3, instead of shifting guidance line 134 so that the end 138 of implement 104 is within boundary 108 for the entire pass along boundary 108, the path planning system 105 shifts portions of the guidance line 134 to avoid contact between implement 104 and obstacles 140-142. Therefore, as tractor 102 approaches the location where end 138 of implement 104 may collide with obstacle 140, tractor 102 follows a shifted portion or section 152 to begin deviating from the original guidance line 134 to move end 138 away from obstacle 140. Then, tractor 102 travels along guidance line section 154 to return to the original guidance line 134, having navigated the end 138 of implement 104 around obstacle 140. Then, as the implement 104 approaches obstacle 142, a portion of the guidance line again deviates away from the original guidance line 134, along guidance line section 156 so that end 138 of implement 104 will not collide with obstacle 142. After clearing obstacle 142, tractor 102 then navigates along guidance line section 158 to return to the original guidance line 134. Thus, in the example shown in FIG. 3, path planning system 105 changes the guidance line 134 to deviate around obstacles 140 and 142, without shifting the entire guidance line 134 inwardly relative to boundary 108. It will also be noted that tractor 102 may follow a path that is different from the path followed by implement 104 when traveling along a curve. Therefore, based on the machine dimensions (including the widths of the machines, the connection point or hitch point, the wheel separation, kinematic information and other dimensions that affect the path of the machines) path planning system 105 calculates the path that will be followed by implement 104 so the guidance line sections 152, 154, 156, and 158 can be computed so that implement 104 avoids the obstacles 140-142.

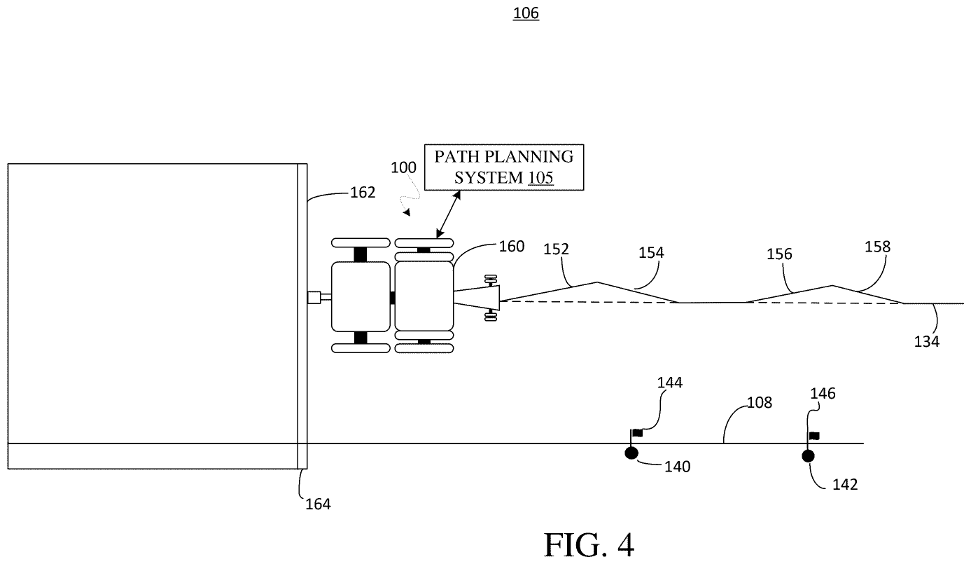

FIG. 4 shows another example in which some items are similar to those shown in FIG. 3, and they are similarly numbered. However, in FIG. 4, agricultural machine 100 includes a sprayer 160 that carries a boom 162. Sprayer 160 is provided with a guidance line 134 which allows the end 164 of boom 162 to operate across and outside of boundary 108 of field 106. For example, it may be desirable to spray slightly outside of boundary 108 to avoid encroachment of weeds or pests into field 106. Therefore, in some scenarios such as that shown in FIG. 4, machine 100 travels along guidance line 134 so that its operating width (or track width) is intended to operate outside of field boundary 108. Even though there may be relatively little or no overhang portion on boom 162, the part of boom 162 proximate end 164 of boom 162 will still potentially collide with obstacles 140-142 as machine 100 approaches those obstacles. Therefore, as with the example shown in FIG. 3, path planning system 105 re-generates guidance line 134 based upon the track width or operating width of boom 162, and based upon the location of obstacles 140-142. The guidance line 134 is thus re-generated with guidance line portions 152, 154, 156, and 158 so that machine 100 navigates in a way to avoid colliding with obstacles 140 and 142, yet continues to operate in a way that boom 162 continues to spray at least partially outside of boundary 108 in other areas where there are no obstacles to avoid.

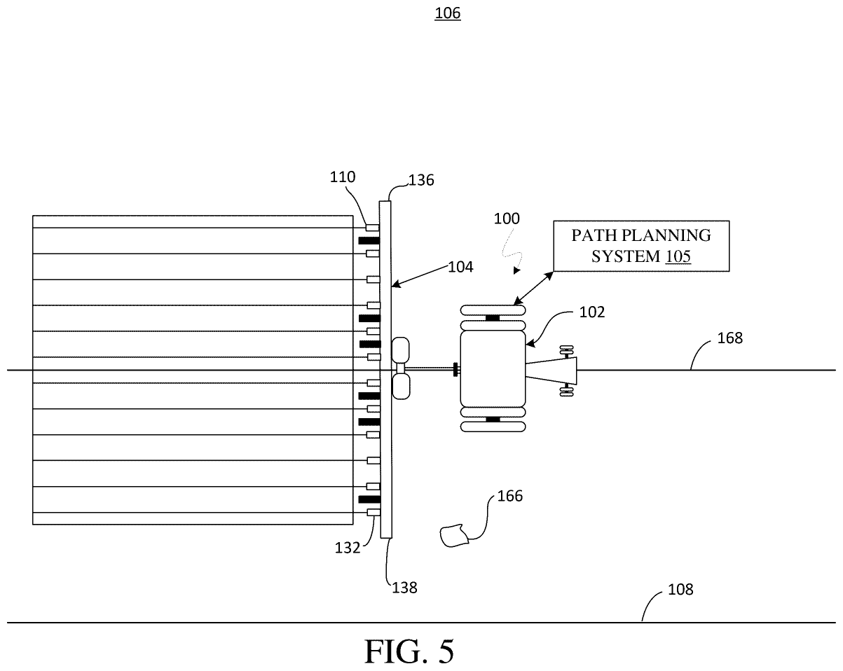

FIG. 5 is similar to FIG. 3, and similar items are similarly numbered. However, in FIG. 5, machine 100 is now operating fully within boundary 108 so that even the overhang portions of implement 104 do not cross boundary 108. However, in FIG. 5, an obstacle, such as a rock, 166 is inside of the boundary 108 of field 106. Guidance line 168 has been generated for machine 100, and machine 100 is following guidance line 168. The guidance line 168 has been generated, again, as with guidance line 134, based upon the operating width or track width of implement 104, as measured between row units 110 and 132. Therefore, if tractor 102 continues to follow guidance line 168, the overhang end 138 of implement 104 will collide with obstacle 166.

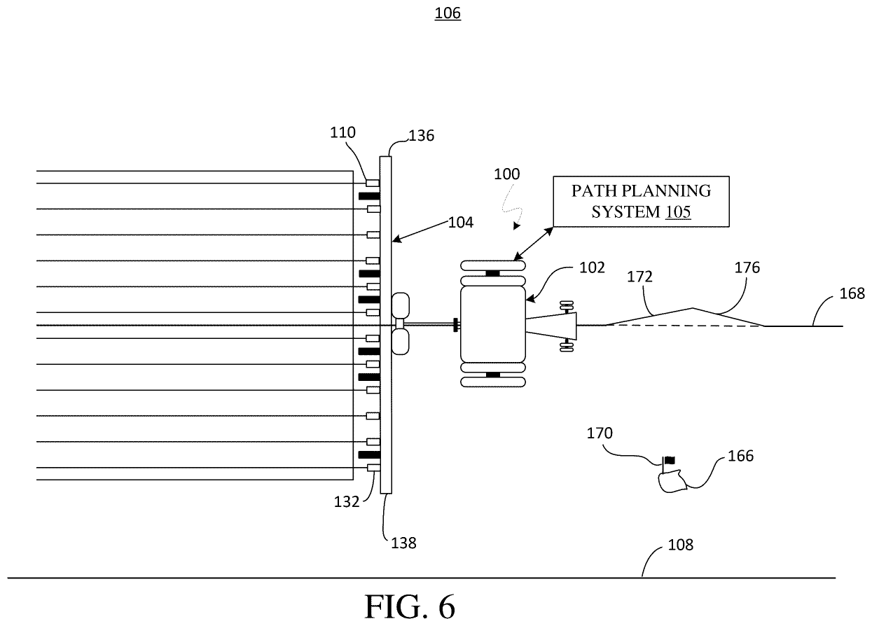

FIG. 6 is similar to FIG. 5, and similar items are similarly numbered. However, in FIG. 6, obstacle 166 has now been marked with a flag 170. The location of obstacle 166 can, as with obstacles 140 and 142, be detected automatically or identified by an operator placing a flag 170 at the location of obstacle 166 in a mapping system using an operator input, or in other ways. Path planning system 105 obtains the overall width of implement 104 and thus re-generates guidance line 168 based upon the location of obstacle 166, and based upon the overall width of implement 104 measured between ends 136 and 138. Therefore, guidance line 166 has been re-generated to include guidance line sections 172 and 176. As tractor 102 travels along the re-generated guidance line 168 and follows guidance line sections 172 and 176, the end 138 of implement 104 will travel around, and thus avoid, obstacle 166. Thus, path planning system 105 can re-generate the guidance lines, based upon the overall width of the implement, in order to avoid obstacles that lie within the field boundary 108 as well as to avoid obstacles that lie outside the field boundary 108 and where the obstacles may be contacted by overhang portions of implement 104.

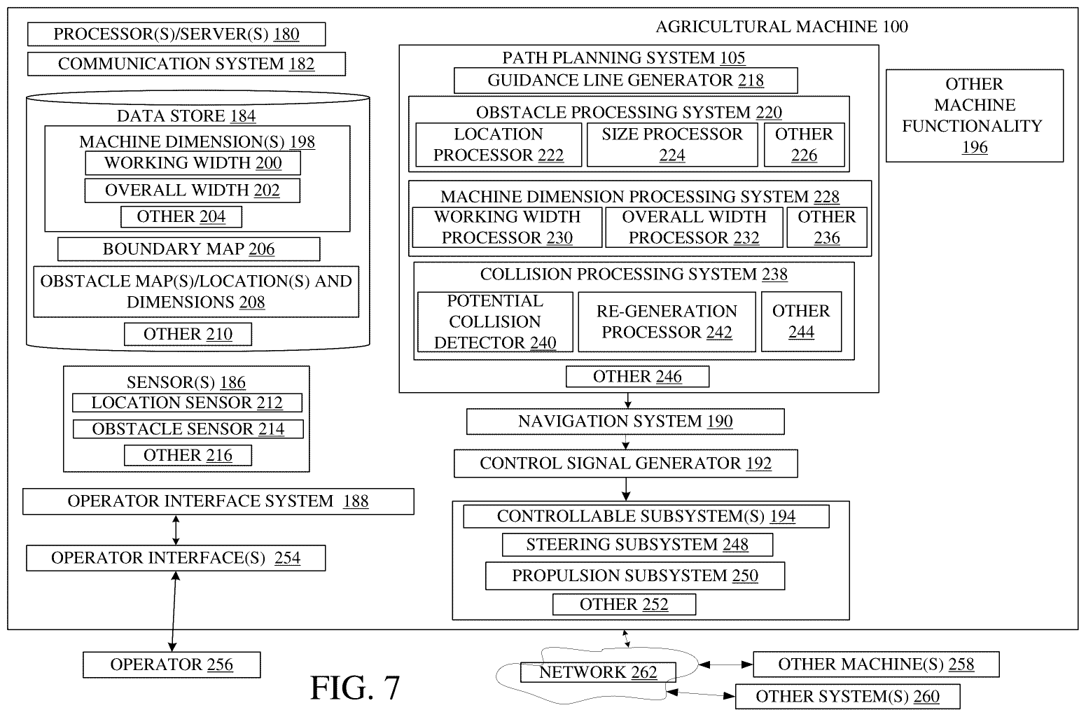

FIG. 7 is a block diagram showing some portions of agricultural machine 100 in more detail. In FIG. 7, agricultural machine 100 includes one or more processors or servers 180, communication system 182, data store 184, sensors 186, computer interface system 188, path planning system 105, navigation system 190, control signal generator 192, controllable subsystems 194, and other machine functionality 196. Data store 184 can include machine dimensions 198 (such as working width 200, overall width 202, and other dimensions 204), boundary map 206, obstacle maps/locations and dimensions 208, and other items 210. Sensors 186 can include location sensor 212, one or more obstacle sensors 214, and other items 216. Path planning system 105 can include guidance line generator 218, obstacle processing system 220 (which includes location processor 222, size processor 224, and other items 226), machine dimension processing system 228 (which includes working width processor 230, overall width processor 232, and other items 236), collision processing system 238 (which includes potential collision detector 240, re-generation processor 242, and other items 244), and path planning system 105 can include other items 246 as well. Controllable subsystems 194 can include steering subsystem 248, propulsion subsystem 250, and other items 252.

In FIG. 7, operator interface system 188 is shown generating operator interfaces 254 for interaction by operator 256. FIG. 7 also shows that, in one example, agricultural machine 100 can communicate with other machines 258 and other systems 260 over network 262. Other machines 258 can include other machines operating in the same field as machine 100, tender vehicles, maintenance vehicles, etc. Other systems 260 can include farm manager systems, maintenance systems, or other systems. Network 262 can include a wide area network, a local area network, a near field network, a Wi-Fi or Bluetooth network, a cellular network, or any of a wide variety of other networks or combinations of networks.

Before describing the overall operation of agricultural machine 100 in more detail, a description of some of the items in agricultural machine 100, and their operation, will first be provided. Communication system 182 facilitates communication of the items on agricultural machine 100 with one another. Therefore, communication system 182 can be a controller area network (CAN) bus and bus controller. Communication system 182 may also facilitate communication with other machines 258 and other systems 260 over network 262. Therefore, the functionality in communication system 182 may vary depending upon the type of network 262 that it communicates over.

Machine dimensions 198 may be the dimensions of implement 104 and/or other machines. Machine dimensions 198 may be downloaded as soon as tractor 102 is connected to implement 104 or at other times. Machine dimensions 198 may be for multiple machines, and indexed by make and model, or indexed by type of implement, or in indexed in other ways. The machine dimensions 198 may be automatically detected or communicated to machine 100, input by operator 256 through operator interface 254, or obtained in other ways as well. Working width 200 identifies the track width of the implement (such as measured between row units 110 and 132 on implement 104 and/or such as measured between the ends of boom 162 in FIG. 4, or in other ways). Overall, width 202 identifies the width of the machine (in a direction transverse to the direction of travel) from one physical end of the implement to the other physical end (such as between ends 136 and 138 of implement 104).

Boundary map 206 may be a map that identifies the boundaries of the field in which machine 100 is operating, or is to operate. The boundary map 206 may identify the external boundaries of the field as well as internal boundaries of areas that are to be excluded from the field, such as waterways, rock piles, etc., or other areas that are to be excluded from the field for the purposes of the operation being performed by agricultural machine 100.

Obstacle maps/locations and dimensions 208 identify the locations and sizes or dimensions of different obstacles which agricultural machine 100 may encounter when performing an agricultural operation. The obstacle maps/locations and dimensions 208 may already be saved for a field and downloaded when agricultural machine 100 is to operate in that field. The obstacle maps/locations and dimensions 208 may be input by operator 256 through an operator interface 254 or may be automatically detected by sensors 186. There may be a variety of different types of obstacles that can have different types of locations and dimensions. For instance, a fence line May be a two-dimensional line type of obstacle that is drawn between two points on a map. Other obstacles may be a point type of obstacle. The location of a point type of obstacle, such as a power pole or rock, etc., may be a single point location, with dimensions defining the size of the obstacle located at that point. The obstacle maps/locations and dimensions data 208 can also identify an area type of obstacle. To define an area type of obstacle, an operator 256 can drive around an area with a location sensor, capturing the location of the route, mark an area on a map, or identify an area in other ways.

Location sensor 212 can include a global navigation satellite system (GNSS) receiver or another type of sensor that senses the location of agricultural machine 100 in a local or global coordinate system. Therefore, location sensor 212 can also be a dead reckoning system, inertial measurement unit, accelerometer, a cellular triangulation system, or any of a wide variety of other location sensors. Obstacle sensors 214 can include sensors that sense obstacles in the vicinity of agricultural machine 100. Such sensors can include optical sensors (such as a stereo camera with image processing functionality), RADAR sensors, LIDAR sensors, ultrasonic sensors, mechanical sensors, among others. When an obstacle is sensed, the location of that obstacle can be correlated to the location output from location sensor 212. Also, where, for example, image processing functionality or other analysis functionality is provided, that functionality can be used to generate the size or dimensions of the obstacle automatically as well.

Operator interface system 188 includes operator interface mechanisms that operator 258 can use to control and manipulate agricultural machine 100. Therefore, operator interface system 188 can include a steering wheel, joysticks, pedals, levers, linkages, buttons, knobs, among other things. Operator interface system 188 can also include a display device that displays operator interfaces 254 for operator interaction. The display device may display operator actuatable items, such as icons, links, buttons, etc. that can be actuated using a point-and-click device, using touch gestures (where the operator interface mechanism is a touch screen), and/or voice commands (where speech recognition and/or speech synthesis are provided). Operator interface system 188 can provide other mechanisms that provide audio, visual, and/or haptic outputs to operator 256 and/or receive inputs from operator 256.

Path planning system 105 generates a guidance line (or a set of guidance lines which may be connected to form a route) and outputs that guidance line or set of guidance lines to navigation system 190. Navigation system 190 provides an output to control signal generator 192 which generates control signals to control controllable subsystems 194 in order to follow the guidance line. Path planning system 105 may be a local or global path planning system and can implement any of a wide variety of different algorithms, such as the Dijkstra algorithm, an A-star algorithm, a D-star algorithm, or any of a wide variety of other path planning algorithms. Navigation system 190 can include deterministic, non-deterministic, or other types of algorithms. Navigation system 190 can include path guidance or other systems as well. Guidance line generator 218 can access the boundary map 206 and machine dimensions 198 and generate one or more guidance lines within the field boundary for navigation of agricultural machine 100. In doing so, guidance line generator 218 may use the working width or track width 200 of machine 100 to generate those guidance lines in order to ensure that substantially the entire field is covered by machine 100.

Obstacle processing system 220 then obtains the location and size of any obstacles in or adjacent the field. It will be noted that generator 218 and the other systems in path planning system 105 can operate simultaneously or sequentially in various different orders. One such order is described herein as an example only. Machine dimension processing system 228 identifies the different dimensions of agricultural machine 100 (such as the working width of the machine 100 and the overall width of machine 100, the connection or hitch point, kinematic information indicating the travel path of implement 104 given the travel path of tractor 102, etc) and collision processing system 238 uses the location and size of the obstacles, as well as the overall width and travel paths of machine 100, to determine whether a collision is likely to occur between any point of machine 100 and any of the obstacles (and specifically between the overhang portions of machine 100 which extend beyond the track width or operating width of machine 100 and the obstacles). Collision processing system 238 then re-generates one or more of the guidance lines, or a portion of one or more of the guidance lines to ensure that navigation system 190 navigates agricultural machine 100 around the obstacles so that no collision occurs.

More specifically, location processor 222 in obstacle processing system 220 may access the obstacle maps/locations and dimensions 208 in data store 184 to identify where the obstacles are located. Size processor 224 can access the dimension data corresponding to each of the obstacles, as well as the location data, and determine the size or outline of the obstacles. Working width processor 230 identifies the type of agricultural machine 100 and accesses the working width 200 for that machine. Overall width processor 232 identifies the type of machine 100 and accesses the overall width 202 for that machine.

Collision processing system 238 then determines whether a collision may exist given the guidance lines generated by guidance line generator 218, the location and size of the various obstacles, and the machine dimensions and kinematics. Potential collision detector 240 generates a set of potential collision parameters corresponding to potential collisions. In one example, potential collision detector 240 selects the different guidance lines and the location and size of various obstacles that are within the overall width of machine 100 as it moves along the selected guidance line. If a potential collision is identified (e.g., analysis shows that a portion of the implement will intersect with a portion of an obstacle), then potential collision detector 240 generates and outputs the set of parameters indicative of a location where the potential collision will occur, and a deviation from the guidance line (in direction and magnitude) that needs to occur to avoid the collision. Based on that output, re-generation processor 242 invokes guidance line generator 218 to re-generate the guidance line or a portion of the guidance line so that agricultural machine 100 can follow the re-generated guidance line to avoid the potential collision.

Thus, as referred to above with respect to FIG. 2, the entire guidance line 148 can be shifted to avoid the collision. Also, as discussed above with respect to FIGS. 3, 4, and 6, a deviation from the guidance line can be generated so that the overall guidance line remains the same, but the deviation navigates agricultural machine 100 around any obstacles. Further, as discussed above, the obstacles may be outside the boundary 108 of the field 106 or within the boundary 108 of the field 106. The re-generated guidance line is then output to navigation system 190 for use in navigating agricultural machine 100.

Control signal generator 192 generates control signals to control the controllable subsystems 194. Steering subsystem 248 can include a steering wheel, joystick, steerable wheels, tracks or wheels or other ground engaging elements that can be steered in a skid steer fashion, or other elements. Propulsion subsystem 250 can include a combustion engine, one or more hydraulic motors, electric motors, etc. Propulsion subsystem 250 can provide propulsion to ground-engaging elements, such as wheels or tracks, through a transmission or by a direct drive system. Propulsion subsystem 250 can provide propulsion to all of the wheels or ground engaging elements or to one or more subsets of the wheels or ground engaging elements.

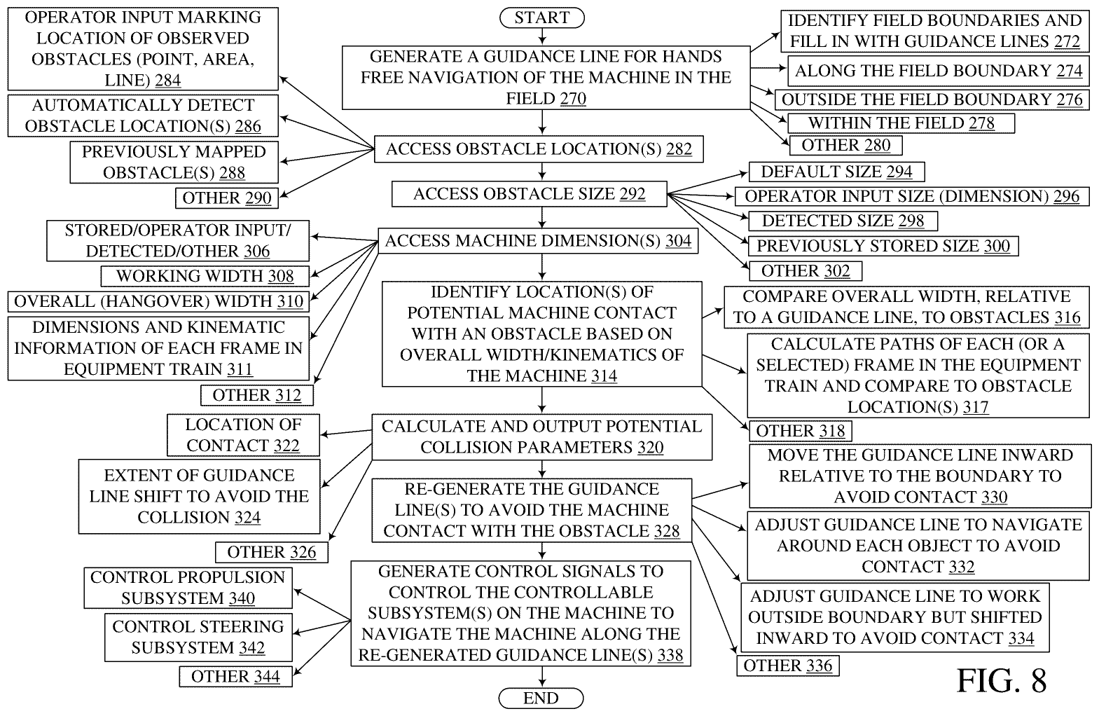

FIG. 8 is a flow diagram illustrating one example of the operation of path planning system 105 and navigation system 190 in identifying potential collisions with obstacles, based upon the overall width of agricultural machine 100, and re-generating a guidance line, or a portion of a guidance line, to avoid the collisions. It is first assumed that guidance line generator 218 generates a guidance line for manual, hands free (or automated) navigation of agricultural machine 100 in the field 106. The guidance line can be generated by guidance line generator 218 just prior to operation, during operation, or ahead of time and downloaded (such as from a remote server environment). Generating the guidance line is indicated by block 270 in the flow diagram of FIG. 8. In one example, guidance line generator 218 obtains the identity of the field for which guidance lines are to be generated and accesses field boundary data from boundary map 206 corresponding to the field. Guidance line generator 218 then accesses the machine dimensions 198 and calculates a set of guidance lines to fill the bounded area of the field with guidance lines. Identifying field boundaries and filling in the field boundaries with guidance lines is indicated by block 272.

In one example, guidance lines are generated along the field boundaries so that the edges of the working width of machine 100 are closely adjacent the boundaries, as indicated by block 274. In some examples, guidance lines are generated so that the working width of the machine 100 extends beyond or outside the boundaries as indicated by block 276. The guidance lines may be generated not only along the boundaries of the field, but also within the field boundaries, across the entire field as well, as indicated by block 278. Other guidance lines can be generated, and the guidance lines can be generated in other ways, as indicated by block 280.

Obstacle processing system 220 then accesses data corresponding to obstacles which may provide a collision risk. Location processor 222 accesses the obstacle locations, as indicated by block 282 in the flow diagram of FIG. 8. The obstacle locations can be obtained through an operator input which marks locations of observed obstacles, as indicated by block 284. The types of obstacles may be identified as well, such as a point, an area, a line, etc. A point obstacle may identify such things as a rock, a power pole, etc. An area obstacle may identify such things as a waterway, a drain tile, a muddy area of the field, etc. A line obstacle may identify such things as a fence line, a tree line, etc.

In another example, the obstacle locations may be automatically detected using obstacle sensors 214 and location identifiers (e.g., coordinates) from location sensor 212. Automatically detecting obstacle locations is indicated by block 286 in the flow diagram of FIG. 8. In another example, the obstacles may be previously mapped obstacles which are downloaded and accessed by location processor 222, as indicated by block 288 in the flow diagram of FIG. 8. The obstacle locations can be obtained in other ways as well, as indicated by block 290.

Size processor 224 then accesses the sizes corresponding to the detected obstacles. Accessing obstacle size is indicated by block 292 in the flow diagram of FIG. 8. Size processor 224 can identify the size of an obstacle using a default size given the type of obstacle (e.g., a power pole, etc.) as indicated by block 294. The obstacle size can be received by operator input (such as the operator inputting a set of dimensions (e.g., a radius from a point, a length of a line, an outline of an area, etc.) as indicated by block 296. The size of the obstacle can be detected, such as by using an optical sensor and image processing functionality, as indicated by block 298 in the flow diagram of FIG. 8. The obstacle sizes may be previously detected or generated and stored so that they simply need to be accessed from data store 184, as indicated by block 300. The obstacle sizes can be accessed in other ways as well, as indicated by block 302.

Machine dimension processing system 228 then processes machine dimensions for machine 100. Machine dimension processing system 228 accesses the machine dimensions that will be used to identify potential collisions with objects. Accessing machine dimensions is indicated by block 304 in the flow diagram of FIG. 8. The machine dimensions can be previously stored in data store 184, obtained through an operator input from operator 256, detected by a dimension detector (such as an optical detector and image processor) or communicated to machine 100 or received in other ways, as indicated by block 306. In one example, working width processor 230 obtains the working width 200 of the machine, as indicated by block 308, and overall width processor 232 obtains the overall width (including the hangover width of the machine which extends beyond the working width) as indicated by block 310 in the flow diagram of FIG. 8. In one example, machine dimension processing system 228 accesses dimension and kinematic information corresponding to each frame of agricultural machine 100 (such as the implement(s) 104, tractor 102, etc.) which indicates how the different frames of the different parts of machine 100 will move, such as along curves, etc., as indicated by block 311. Other machine dimensions can be obtained and the dimensions can be obtained in other ways as well, as indicated by block 312.

Collision processing system 238 then identifies locations of potential machine contact with an obstacle based upon the overall width/kinematics of the different frames of machine 100, as indicated by block 314 in the flow diagram of FIG. 8. For instance, in one example, potential collision detector 240 selects a guidance line and compares the overall width of machine 100, relative to the location of the guidance line, to the location and size of an obstacle to determine whether the machine will intersect with that obstacle at any point along the guidance line. Comparing the overall machine width, relative to the guidance lines, to obstacle locations and dimensions to identify potential collisions is indicated by block 316 in the flow diagram of FIG. 8. In another example, the kinematics and dimensions can be used to calculate the paths of tractor 102 and/or one or more implements 104 (or other frames in the train of equipment in agricultural machine 100) for one or more different guidance lines and compare the path(s) to the location of the obstacles to identify potential collisions, as indicated by block 317 in FIG. 8. Potential collisions can be identified in other ways as well, as indicated by block 318.

Potential collision detector 240 then calculates and outputs potential collision parameters corresponding to any identified potential collisions, as indicated by block 320 in the flow diagram of FIG. 8. The potential collision parameters may include the location where the machine/obstacle collision or contact will occur, as indicated by block 322. The potential collision parameters may also include the distance by which the guidance line needs to be moved, at the location of the collision, in order to avoid the collision, as indicated by block 324 in the flow diagram of FIG. 8. The potential collision parameters can include any of a wide variety of other parameters expressed in other ways as well, as indicated by block 326 in the flow diagram of FIG. 8.

Based upon the output from potential collision detector 240, re-generation processor 242 controls guidance line generator 218 to re-generate the guidance line (or portions of the guidance line) in order to avoid contact between machine 100 and the obstacle. Re-generating the guidance line is indicated by block 328 in the flow diagram of FIG. 8. The guidance line can be re-generated in a wide variety of different ways. For instance, and as described above with respect to FIG. 2, the entire guidance line can be shifted (e.g., shifted inward relative to the boundary). As an example, where the guidance line 134 is drawn proximate a boundary 108, then the entire guidance line can be moved inward relative to the boundary 108 to avoid contact with an obstacle, as indicated by block 330 in the flow diagram of FIG. 8. In another example, such as discussed above with respect to FIGS. 3 and 6, the guidance line can be adjusted to navigate around each of the obstacles in order to avoid contact, yet maintain the rest of the guidance line in its original location, as indicated by block 332 in the flow diagram of FIG. 8. In yet another example as discussed above with respect to FIG. 4, the guidance line can be adjusted so that agricultural machine 100 works outside the boundary of a field, but is shifted inward to avoid contact with any obstacles, as indicated by block 334. Of course, the guidance lines can be re-generated to avoid potential collisions in any of a wide variety of other ways as well, as indicated by block 336 in the flow diagram of FIG. 8. The re-generated guidance line is then output to navigation system 190 which uses control signal generator 192 to generate control signals to control the controllable subsystems 194 on machine 100 to navigate the machine 100 along the re-generated guidance lines, as indicated by block 338 in the flow diagram of FIG. 8. The control signals can be used to control propulsion system 250, as indicated by block 340 in the flow diagram of FIG. 8, and/or to control steering subsystem 248, as indicated by block 342 in the flow diagram of FIG. 8. The control signals can be used to control the controllable subsystems 194 in other ways as well, as indicated by block 344.

It can thus be seen that the present description describes a system that uses the overall width of an agricultural machine, as opposed to just the working width or track width, to generate guidance lines so that the machine can be navigated to avoid a collision with obstacles, even where the collision would occur with a portion of the agricultural machine that is outside of the working width or track width of the agricultural machine. This can be helpful in all regions of the field, and may be particularly helpful when the machine is operating adjacent the field boundary.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, they can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, sensors, and/or logic. It will be appreciated that such systems, components, generators, sensors, and/or logic can be comprised of hardware items (such as processors and associated memory, or other processing components, some of which are described below) that perform the functions associated with those systems, components, generators, sensors, and/or logic. In addition, the systems, components, generators, sensors, and/or logic can be comprised of software that is loaded into a memory and is subsequently executed by a processor or server, or other computing component, as described below. The systems, components, generators, sensors, and/or logic can also be comprised of different combinations of hardware, software, firmware, etc., some examples of which are described below. These are only some examples of different structures that can be used to form the systems, components, generators, sensors, and/or logic described above. Other structures can be used as well.

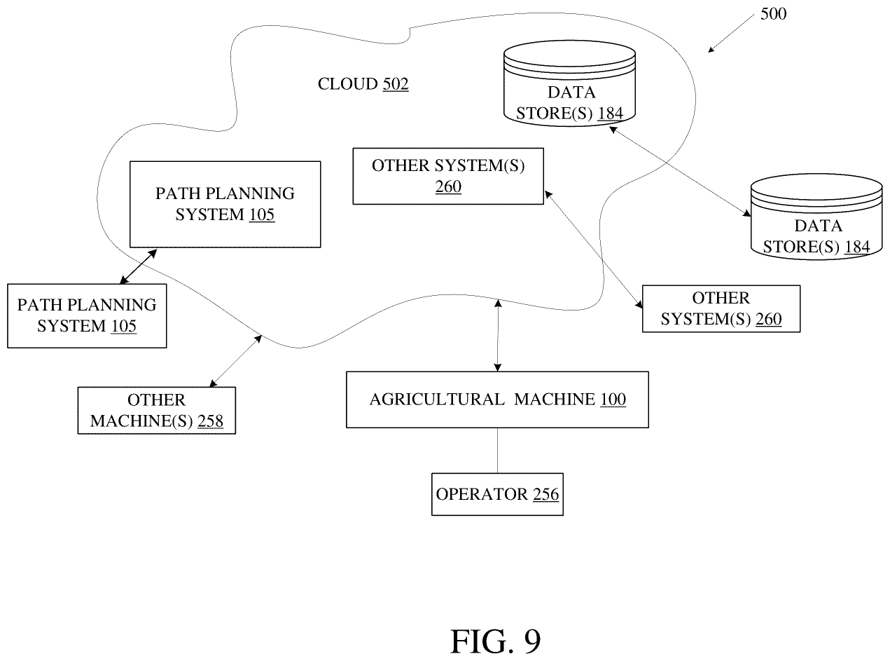

FIG. 9 is a block diagram of machine 100, shown in other FIGS., except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver 6 applications over a wide area network and they can be accessed through a web browser or any other computing component. Software or components shown in previous FIGS. as well as the 8 corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 9, some items are similar to those shown in previous FIGS. and they are similarly numbered. FIG. 9 specifically shows that path planning system 105, data store 184, and other systems 200 can be located at a remote server location 502. Therefore, machine 100 accesses those systems through remote server location 502.

FIG. 9 also depicts another example of a remote server architecture. FIG. 9 shows that it is also contemplated that some elements of previous FIGS. are disposed at remote server location 502 while others are not. By way of example, data store 184 or other systems 260 can be disposed at a location separate from location 502, and accessed through the remote server at location 502. Regardless of where they are located, they can be accessed directly by machine 100, through a network (either a wide area network or a local area network), they can be hosted at a remote site by a service, or they can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

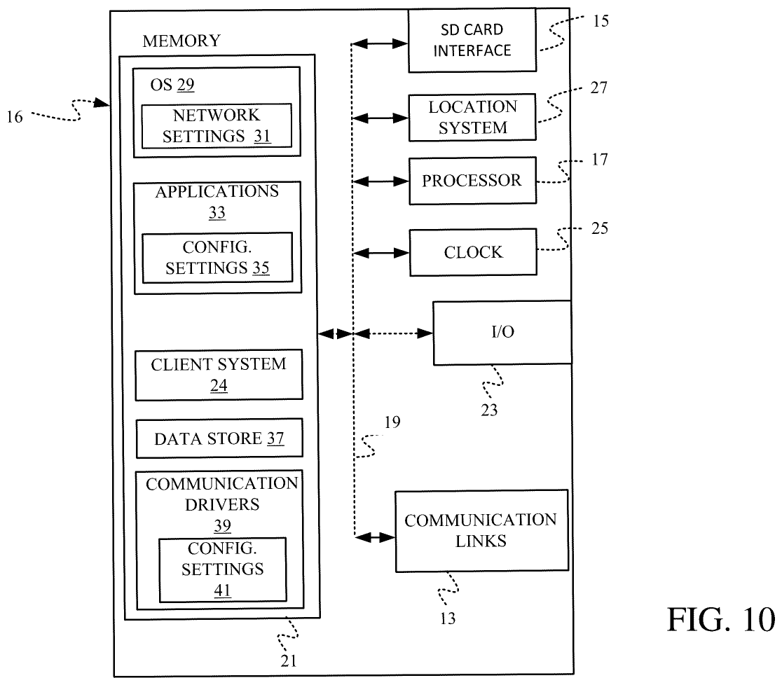

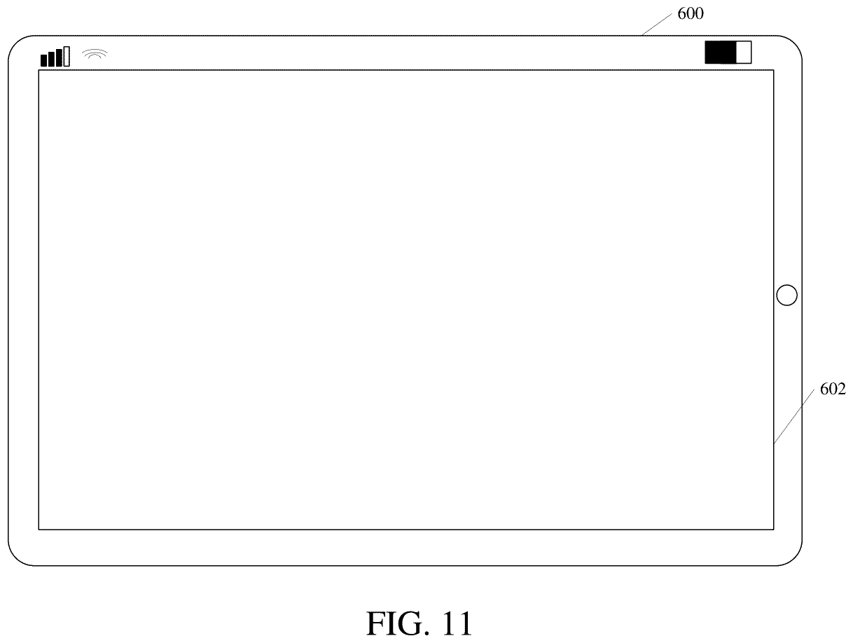

FIG. 10 is a simplified block diagram of one illustrative example of a handheld or mobile computing device that can be used as a user's or client's hand held device 16, in which the present system (or parts of it) can be deployed. For instance, a mobile device can be deployed in the operator compartment of machine 100 for use in generating, processing, or displaying the guidance lines, obstacles, maps, etc. FIGS. 11-13 are examples of handheld or mobile devices.

FIG. 10 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. Clock 25 can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media 6 (described below). Memory 21 stores computer readable instructions that, when executed by processor 17, cause the processor to perform computer-implemented steps or functions according to the instructions. Processor 17 can be activated by other components to facilitate their functionality as well.

FIG. 11 shows one example in which device 16 is a tablet computer 600. In FIG. 11, computer 600 is shown with user interface display screen 602. Screen 602 can be a touch screen or a pen-enabled interface that receives inputs from a pen or stylus. Computer 600 can also 13 use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

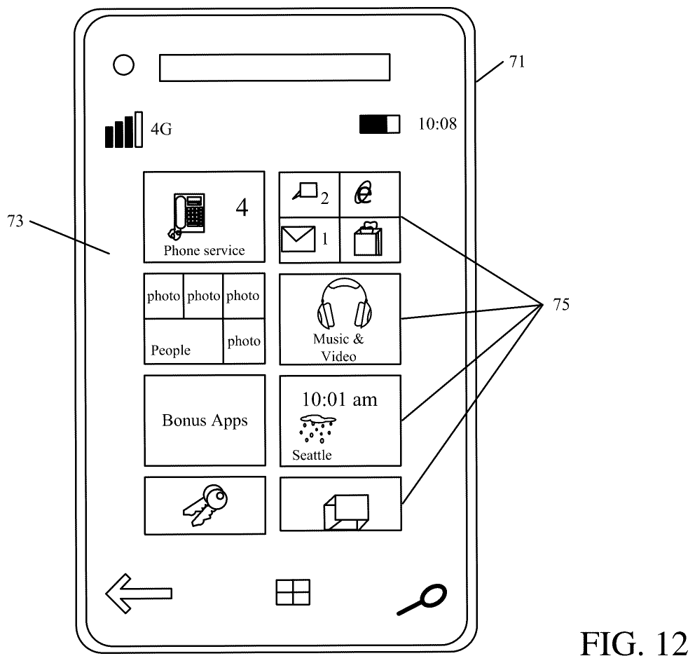

FIG. 12 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

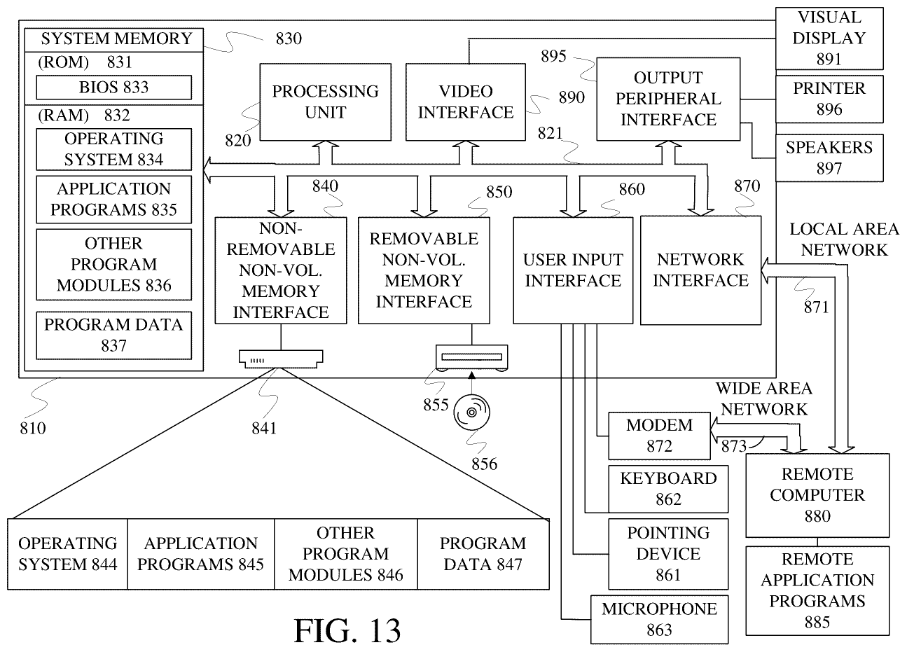

FIG. 13 is one example of a computing environment in which elements of previous FIGS., or parts of it, (for example) can be deployed. With reference to FIG. 13, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited 11 to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media May embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 13 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving a guidance line for navigating an agricultural machine in a work area;
obtaining an overall width of the agricultural machine;
obtaining obstacle data identifying a location of an obstacle;
identifying a potential collision between the agricultural machine and the obstacle based on the overall width of the agricultural machine, the guidance line, and the location of the obstacle;
re-generating the guidance line, to obtain a re-generated guidance line, to avoid the potential collision; and
controlling navigation of the agricultural machine based on the re-generated guidance line.

2. The computer implemented method of claim 1 wherein identifying a potential collision comprises:
calculating a set of potential collision parameters and wherein re-generating the guidance line comprises re-generating the guidance line based on the set of potential collision parameters.

3. The computer implemented method of claim 2 wherein calculating a set of potential collision parameters comprises:
identifying a location of contact between the agricultural machine and the obstacle; and
calculating a guidance line modification to avoid the contact between the agricultural machine and the obstacle.

4. The computer, implemented method of claim 1 wherein the agricultural machine comprises a first machine having a first frame, and a second machine having a second frame, the first machine providing propulsion for the second machine, and wherein obtaining an overall width comprises:
obtaining kinematic information corresponding to the second machine, and wherein identifying a potential collision comprises calculating a path of the second machine based on the overall width, the kinematic information, and the guidance line, and identifying the potential collision based on the path of the second machine and the location of the obstacle.

5. The computer implemented method of claim 1 wherein re-generating the guidance line comprises:
shifting the guidance line to a location to avoid the potential collision.

6. The computer implemented method of claim 1 wherein re-generating the guidance line comprises:
shifting a portion of the guidance line so the agricultural machine is navigated around the obstacle.

7. The computer implemented method of claim 1 wherein the guidance line is positioned to enable a portion of the agricultural machine to perform an agricultural operation over an area outside of a field boundary and wherein re-generating the guidance line comprises:
regenerating a portion of the guidance line to continue to enable the agricultural machine to perform the agricultural operation over a part of the area outside the field boundary; and
shifting a portion of the guidance line so the agricultural machine is navigated around the obstacle.

8. The computer implemented method of claim 1 wherein obtaining obstacle data comprises:
obtaining obstacle dimension data indicative of a dimension of the obstacle and wherein identifying a potential collision between the agricultural machine and the obstacle comprises identifying the potential collision based on the dimension of the obstacle.

9. The computer implemented method of claim 1 wherein obtaining obstacle data comprises:
automatically detecting the obstacle location and obstacle dimensions.

10. The computer implemented method of claim 8 wherein obtaining obstacle data comprises:
detecting an operator input indicative of an obstacle location and an obstacle type.

11. The computer implemented method of claim 10 wherein detecting an operator input indicative of an obstacle type comprises:
detecting the operator input indicating that the obstacle is a point obstacle type, the obstacle location being a point, wherein obtaining obstacle dimension data comprises obtaining the obstacle dimension data indicative of a size of the obstacle at the point.

12. The computer implemented method of claim 10 wherein detecting an operator input indicative of an obstacle type comprises:
detecting the operator input indicating that the obstacle is a line obstacle type, wherein obtaining obstacle dimension data comprises obtaining the obstacle dimension data indicative of a length of the obstacle.

13. The computer implemented method of claim 10 wherein detecting an operator input indicative of an obstacle type comprises:
detecting the operator input indicating that the obstacle is an area obstacle type, wherein obtaining obstacle dimension data comprises obtaining the obstacle dimension data indicative of the area of the obstacle at the obstacle location.

14. The computer implemented method of claim 1 wherein obtaining an overall width of the agricultural machine comprises:
displaying an operator interface with an operator actuatable input mechanism; and
detecting an operator actuation of the operator actuatable input mechanism indicative of the overall width of the agricultural machine.

15. An agricultural system, comprising:
a path planning system configured to generate a guidance line for navigating an agricultural machine in a work area;
an obstacle processing system configured to obtain obstacle data identifying a location of an obstacle;
a potential collision detector configured to access an overall width of the agricultural machine and to identify a potential collision between the agricultural machine and the obstacle based on the overall width of the agricultural machine, the guidance line, and the location of the obstacle;
a re-generation processor configured to control re-generation of the guidance line, to obtain a re-generated guidance line, to avoid the potential collision;
a controllable subsystem; and
a control signal generator configured to control the controllable subsystem to navigate the agricultural machine based on the re-generated guidance line.

16. The agricultural system of claim 15 and further comprising:
an overall width processor configured to obtain the overall width of the agricultural machine.

17. The agricultural system of claim 15 wherein the potential collision detector is configured to calculate a set of potential collision parameters and wherein the re-generation processor is configured to re-generate the guidance line based on the set of potential collision parameters.

18. The agricultural system of claim 17 wherein the re-generation processor is configured to control re-generation of the guidance line by shifting the guidance line to a location to avoid the potential collision based on the set of potential collision parameters.

19. The agricultural system of claim 17 wherein the re-generation processor is configured to control re-generation of the guidance line by shifting a portion of the guidance line, based on the set of potential collision parameters, so the agricultural machine is navigated around the obstacle.

20. A computer system, comprising:
at least one processor; and
a data store storing computer executable instructions which, when executed by the at least one processor, cause the at least one processor to perform steps comprising:
generating a guidance line for navigating an agricultural machine in a work area;
accessing an overall width of the agricultural machine;
obtaining obstacle data identifying a location and dimension of an obstacle;
identifying a potential collision between the agricultural machine and the obstacle based on the overall width of the agricultural machine, the guidance line, and the location and dimension of the obstacle;
re-generating the guidance line, to obtain a re-generated guidance line, to avoid the potential collision; and
navigating of the agricultural machine based on the re-generated guidance line.
